(19) United States
(12) Patent Application Publication
(10) Pub. No.: US 2016/0231054 A1
(43) Pub. Date: Aug. 11, 2016

(54) APPARATUS FOR CURING SENSITIVE SUBSTRATE MATERIALS

(71) Applicant: Air Motion Systems, Inc., River Falls, WI (US)

(72) Inventors: Michael D. Callaghan, Minneapolis, MN (US); Paul J. Wilson, River Falls, WI (US)

(21) Appl. No.: 15/017,367

(22) Filed: Feb. 5, 2016

Related U.S. Application Data
(60) Provisional application No. 62/112,456, filed on Feb. 5, 2015.

(51) Int. Cl. F26B 3/28; B05C 9/12; B05C 1/08; B05D 1/28; B05D 3/06

(52) U.S. Cl. CPC F26B 3/28; B05D 1/28; B05D 3/067; B05C 1/0826; B05C 9/12

(57) ABSTRACT

An apparatus for curing substrate materials may include one or more radiation sources, a rotatable transport cylinder and a conveyor mechanism with a belt or web is disclosed. The substrate is transported by the belt or web and passes between the belt or web and the cylinder, where it is irradiated to cure the substance deposited on the substrate.

### PRIORITY

This application claims priority under 35 U.S.C. §119 (e) to, and hereby incorporates by reference in its entirety, U.S. Provisional Application No. 62/112,456, filed 5 Feb. 2015.

### FIELD

This invention relates to an apparatus for curing deposited substances on a substrate and, in particular, this invention relates to curing substances deposited on a substrate by irradiation.

### BACKGROUND

In the printing industry, use of UV-curable inks and other substances is increasing, due to the increasingly fast curing rates effected by UV radiation. If the substance printed on the substrate not cured and dried quickly, the entire printing procedure must be slowed or the deposited substance will be unacceptably smeared and distorted. Rapidly operating printing thus requires essentially instant curing of printed inks or materials. This invention substantially meets the aforementioned needs of the industry by providing an apparatus to efficiently and quickly cure substances deposited on a substrate by irradiation.

### SUMMARY

The disclosure includes an apparatus for curing a substrate. The apparatus may include a first radiation source with a light-emitting diode; a rotatable transport cylinder transfer transmitting radiation from the first radiation source onto a substrate; and a conveyor frame and a conveyor belt moving on the conveyor frame. The transport cylinder may rotate at a speed matching a velocity of the conveyor belt. The substrate may be transported by the conveyor belt such that the substrate is disposed between the conveyor belt and a transport cylinder when being irradiated. The transport cylinder may include glass or a transmissive polymer, such as an acrylic polymer. Suitable acrylic polymers include Acrylite OP-4, CYRO Industries, Parsippany, N.J.; and Polycast Solacryl SUVT, Stamford, Conn.

The disclosure further includes a plurality of combinations, each combination comprising the radiation source and rotating cylinder of this invention, each combination disposed along a conveyor belt and positioned to irradiate a substrate being conveyed along the conveyor belt.

The disclosure yet further includes a method of irradiating a substrate, the method comprising conveying the substrate until the substrate is positioned between a conveyor belt and a rotating cylinder; and emitting radiation from a light emitting diode such that UV light from the diode is transmitted through the rotating cylinder to impinge and cure a substance on the surface of the substrate.

The disclosure additionally includes a method of manufacturing an apparatus for curing UV-sensitive materials deposited on a substrate. This method may include supporting a conveyor mechanism, cylinder rotating mechanism, and UV-radiation source including a light-emitting diode, on a frame such that light from the radiation source is transmitted through the rotating cylinder to impinge a surface of the substrate.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a perspective view of the apparatus for curing substrate materials according to certain example embodiments.

FIG. 2 is an enlarged, partial view of the apparatus of FIG. 1.

FIG. 3 is an enlarged, partial side view of the apparatus of FIG. 1.

FIG. 4 is an enlarged, partial side view of the apparatus of FIG. 1, depicting a substrate being conveyed between the transport cylinder and the belt.

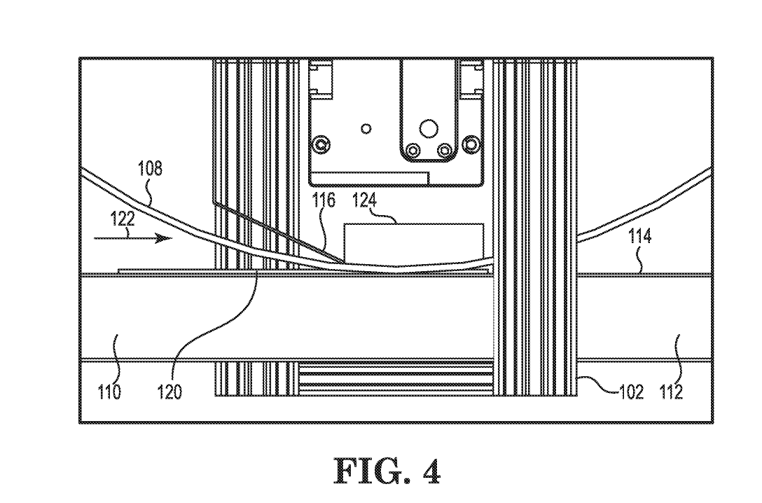

It is understood that the above-described figures are only illustrative of the present invention and are not contemplated to limit the scope thereof.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

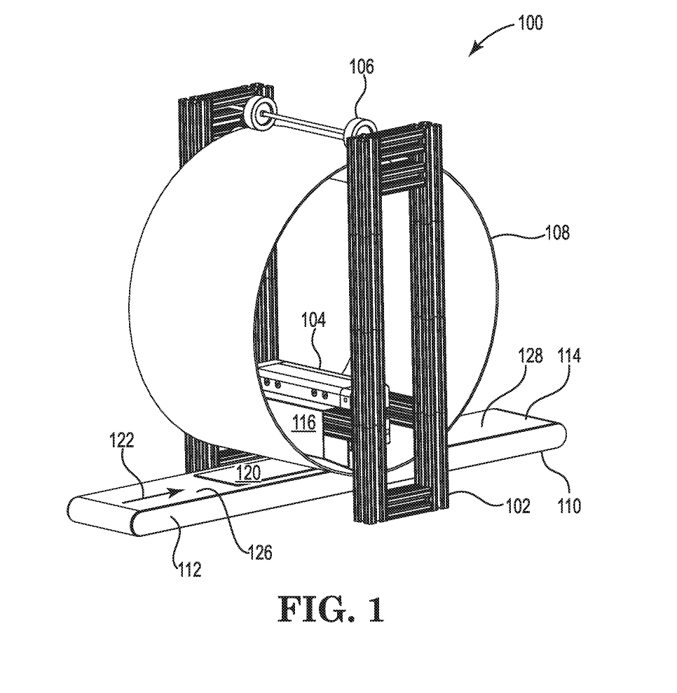

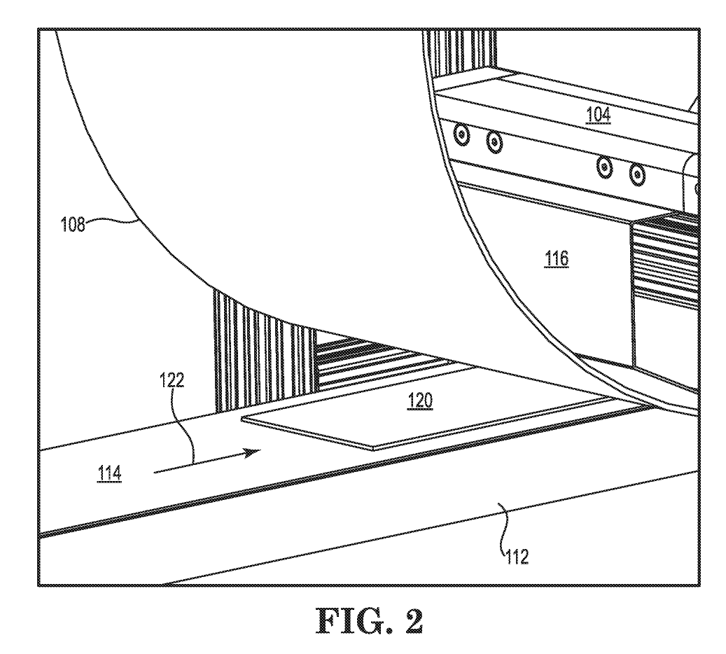

One example embodiment of the present apparatus for curing substrate materials is depicted in the drawings (FIGS. 1, 2) generally at 100 and includes a frame 102, which supports a radiation source 104 and a cylinder-rotating mechanism 106. In the embodiment depicted, the radiation source 104 may include a light emitting diode (LED), optionally emitting ultraviolet (UV) radiation such as wavelengths between 320 nm and 410 nm and having a low infrared emission. A rotating cylinder 108 may be supported and rotated by the cylinder-rotating mechanism 106. Optionally supported by the frame 102 is a conveyor mechanism 110. In the embodiment depicted, the conveyor mechanism 110 includes a conveyor frame 112 and a conveyor belt 114. If present, an irradiation shield 116 is optionally attached to the radiation source 104 in the embodiment depicted. However, an irradiation shield may be attached to the frame 102, or other structure as a person of ordinary skill in the art would realize.

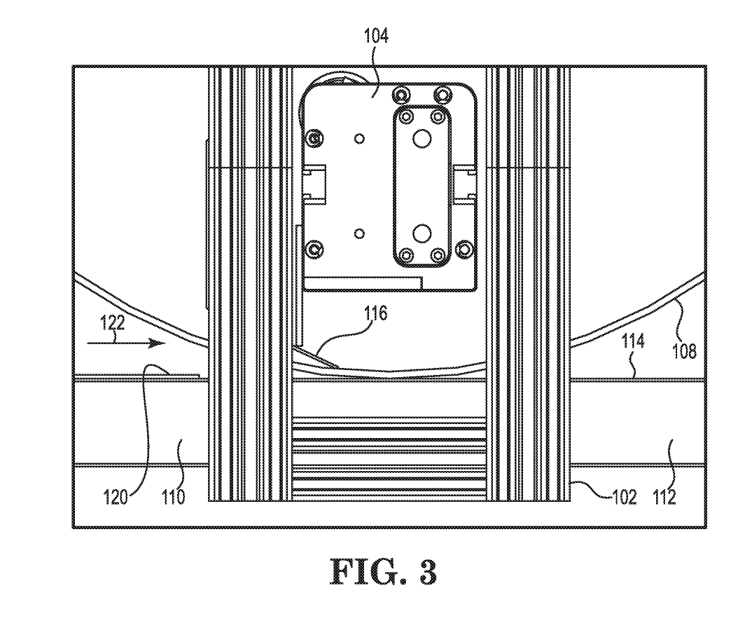

In one exemplary operation, a substrate 120 is transported on the conveyor belt 114 in the direction of the arrow 122. The conveyor belt 114 is operating at a speed substantially identical to the speed of the rotating cylinder 108. Due to the presence of the irradiation shield 116, the substrate 120 is not irradiated by the radiation source 104 until the substrate is past the irradiation shield 116. Once past the area shaded by the irradiation shield 116, the substrate 120 is disposed between the rotating cylinder 106 and the conveyor belt 114. At which point radiation, such as ultraviolet (UV) light waves, is emitted from the radiation source 104, passing through the rotating cylinder 108 and impinging an upper surface of the substrate 120 (FIG. 3). The substrate 120 is further transported by the rotating cylinder 108 and conveyor mechanism 110 through the area 124 being irradiated by the radiation source 104. Once past the area 124, the irradiated and cured substrate is transported to the end of the conveyor mechanism 110 for storage, use, or transport.

Alternatively, the substrate 120 can be additionally irradiated upstream at a point 126 or downstream at a point 128 with respect to the rotating cylinder 108 (FIG. 1).

In the embodiment shown, a curable substance, such as a UV-curable substance, has been deposited, such as printed, on the substrate 120 before being transported through the apparatus of this invention. However, the rotating cylinder 108, itself, may deposit a curable substance on the substrate in another embodiment.

While a single combination having a frame, rotating cylinder, and radiation source is depicted, the instant invention contemplates a plurality of such combinations operationally attached to the instant conveyor mechanism.

Stated otherwise, the cylinder 108 is rotated at a speed sufficient to match the velocity of the conveyor belt 114 to fix the substrate 120 in position and to deposit the irradiation-sensitive material on the substrate 120 without smearing or distortion (if such material has not been previously deposited on the substrate). If the irradiation-sensitive material has been deposited on the substrate 120 by the cylinder 108, the substrate 120 is transported by the conveyor belt 114 and the cylinder 108 to a position inside the irradiation shield 116, where irradiation, such as UV light, is admitted from the radiation source 104. The substrate 120 is continually transported, during and after being irradiated away from the radiation source 104 by the combined cylinder 108 and conveyor belt 114, then solely by the conveyor belt 114.

It is contemplated that the apparatus of this invention may include one or more alternative irradiation sources, which may irradiate or cure materials deposited upstream from where the depicted irradiation source is situated. Although not shown, alternate irradiation sources may be present downstream from the apparatus as well. Additionally the instant cylinder may be machined with a relief such that a three-dimensional pattern to be impressed and cured (imprinted) on the substrate, or layer deposited on the substrate, each cured by irradiation from the source.

In yet another embodiment, the substrate-conveyor combination may be replaced with substrate deployed on a web in a continuous fashion.

It is often desirable to use a cylinder for inerting the surface of ink or coating on the substrate. Accordingly, in the embodiment shown, the instant cylinder is constructed from a clear material, which transmits radiation from the radiation source to the substrate and also hypoxicly seals the substrate from ambient air during irradiation, e.g., to prevent or minimize undesirable side reactions during curing. Suitable materials include acrylic with high irradiation-transmissive characteristics, as well as formulations of glass and other transmissive polymers. In the embodiment shown, the shield 116 is fashioned from polished aluminum. However, other mirror-like reflective materials may be used as well. Suitable sources of radiation include XP Series Modules, manufactured and marketed by Air Motion Systems, Inc., River Falls, Wis.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. An apparatus for curing a substrate, comprising:
a first radiation source with a light emitting diode;
a rotatable transport cylinder transmitting radiation from said first radiation source onto said substrate;
a conveyor mechanism with conveyor frame and a conveyor belt moving on said conveyor frame; said transport cylinder rotating at a speed matching a velocity of said conveyor belt, said substrate transported by said conveyor belt such that said substrate is disposed between said conveyor belt and said transport cylinder when said irradiation from said first radiation source impinges said substrate.

2. The apparatus of claim 1, wherein said transport cylinder includes a transmissive polymer.

3. The apparatus of claim 1, wherein said transport cylinder includes a transmissive acrylic polymer.

4. The apparatus of claim 1, wherein said radiation source is positioned within said transport cylinder.

5. The apparatus of claim 1, wherein UV light is emitted from said first radiation source.

6. The apparatus of claim 1, further comprising a second radiation source.

7. The apparatus of claim 6, wherein said second radiation source is positioned upstream of said first radiation source.

8. The apparatus of claim 6, wherein said second radiation source is positioned downstream of said first radiation source.

9. The apparatus of claim 1, further comprising a rotating mechanism rotating said transport cylinder.

10. The apparatus of claim 9, further comprising an apparatus frame supporting said rotating mechanism, said first radiation source, and said conveyor frame.

11. The apparatus of claim 1, wherein a plurality of radiation sources are present, one of said radiation sources positioned within said rotating cylinder and another of said radiation sources positioned upstream or downstream of said rotating cylinder.

12. The apparatus of claim 11, wherein other said radiation source is positioned upstream of said rotating cylinder.

13. The apparatus of claim 1, wherein said rotating cylinder deposits a substance on said substrate, said substance cured when irradiated by UV light.

14. A plurality of combinations, each combination comprising the radiation source of claim 1 positioned within the rotating cylinder of claim 1, each said combination disposed along the conveyor belt of line 1 and positioned to irradiate a substrate being conveyed by said conveyor belt.

15. A method of irradiating a substrate, comprising:
conveying said substrate until said substrate is positioned between a conveyor belt and a rotating cylinder; and
emitting radiation from a light emitting diode such that UV light from said diode is transmitted through said rotating cylinder to impinge and cure a substance on a surface of said substrate.

16. The method of claim 15, further comprising depositing said substance on said substrate surface.

17. The method of claim 16, wherein said substance is deposited on said substrate surface by said rotating cylinder.

18. The method of claim 15, further comprising irradiating said substrate surface a second time.

19. A method of manufacturing an apparatus for curing UV-sensitive materials deposited on a substrate, comprising supporting a conveyor mechanism, cylinder rotating mechanism, and UV-radiation source including a light emitting diode on a frame such that light from said radiation source is transmitted though a rotating cylinder to impinge a surface of said substrate.

20. The method of claim 19, wherein said rotating cylinder comprises an acrylic polymer.
